(19) United States
(12) Patent Application Publication
(10) Pub. No.: US 2011/0214430 A1
(43) Pub. Date: Sep. 8, 2011

(54) ACCELERATED COOLING OF A GAS TURBINE

(76) Inventors: Ernst Pauli, Zurich (CH); Alexander Derksen, Nussbaumen (CH)

(21) Appl. No.: 13/030,288

(22) Filed: Feb. 18, 2011

(30) Foreign Application Priority Data
Mar. 2, 2010 (CH) 00268/10

(51) Int. Cl. F02C 1/00; F02C 7/12

(52) U.S. Cl. 60/772; 60/806

(57) ABSTRACT

In a method for the fast cooling down of a gas turbine (1) after its operation, and also in a gas turbine (1) useful for carrying out the method, subsequent to the operation of a gas turbine (1), the rotor (8) is operated at low cooling speed (n) in order to cool down the gas turbine (1) which is heated up as a result of operation. This allows service or maintenance operations to be started early and therefore to reduce the shutdown periods of a gas turbine (1). After the operation of the gas turbine (1), cooling is not carried out a constant low cooling speed (n), but the cooling speed (n) is controlled as a function of at least one critical temperature (Tₖ) and/or of time (t). The cooling speed (n) in this case, in dependence upon the critical temperature (Tₖ), is kept as high as the resulting thermal and/or cyclic load allows for realizing a fast cool-down.

This application claims priority under 35 U.S.C. § 119 to Swiss application no. 00268/10, filed 2 Mar. 2010, the entirety of which is incorporated by reference herein.

### BACKGROUND

1. Field of Endeavor

The invention relates to a method for operating a gas turbine and to a gas turbine useful for carrying out the method.

2. Brief Description of the Related Art

During operation of gas turbines, phases of load operation and downtime or maintenance phases alternate. In particular, the maintenance phases are often hindered or delayed by having to await a cool-down of the gas turbine before this gas turbine becomes accessible.

It is known that subsequent to the operation of a gas turbine, the rotor is operated at low speed in order to cool down the gas turbine more quickly, this having been heated up as a result of operation. As a result of the rotation of the rotor and of the rotor blades which are arranged thereupon, cool ambient air is pumped through the flow passage of the compressor, through the combustor and through the turbine. This cool ambient air, during the throughflowing process, absorbs the heat which is stored in the gas turbine, especially the heat stored in the casing and in the rotor, and transports it away. As a result of this, the gas turbine cools down faster so that service or maintenance operations can be started earlier. It is a general aim to reduce the shutdown periods of a gas turbine in order to increase its availability.

Each shutdown of a gas turbine constitutes a cyclic thermal loading for the hot parts and for all structural parts which are heated during operation. As a result of the faster cool-down, temperature gradients and corresponding thermal stresses are created in the gas turbine. Furthermore, a fast cool-down leads to a higher cyclic loading of the heated components, which reduces the service life of the gas turbine. When a gas turbine cools down, there is an incompatibility between the requirement for a fast cool-down, in order to make the gas turbine accessible for an inspection or for maintenance, and the demand for longer service life of the gas turbine.

According to today's procedures, the cool-down is carried out at a speed which allows a cool-down with as little component loading as possible.

In order to accelerate the cooling down, it has been proposed in WO 2006/021520 to at least periodically introduce a liquid into the inducted airflow upstream of the compressor during the cool-down phase, which liquid, for cooling, flows through the flow passage of the compressor, through the combustor and through the turbine of the gas turbine. For introducing the liquid, an injection device is used in this case, as is known for “wet compression” or “high fogging”. With this method, a higher thermal loading is accepted, apparently with the aim of a faster cool-down.

The known methods for cooling down a gas turbine lead either to long cool-down periods or to high thermal loads of the components and to the detriment of service life and correspondingly reduced maintenance intervals which are associated therewith. Both reduce the availability of the power plant for power production and lead to higher specific costs.

### SUMMARY

One of numerous aspects of the present invention includes a method for cooling down a gas turbine, which allows a faster cool-down of the gas turbine with controlled detriment to service life.

Another aspect of the present invention includes a method in which, subsequent to the operation of the gas turbine, a cooling speed is controlled as a function of at least one critical temperature and/or of time. The cooling speed in this case, in dependence upon the at least one critical temperature for realizing a fast cool-down, is kept as high as the resulting thermal and/or cyclic loading allows.

In the conventional method for fast cool-down of a gas turbine, which is also referred to as “forced cooling”, cooling down is carried out at a constant cooling speed. In this case, the maximum thermal loading is reached at the start of the cooling period. The metal temperatures are highest at the start of the cooling process. The cooling-air temperature, that is to say the temperature of the air which is directed through the gas turbine for cooling, is close to the intake temperature of the air which is inducted from the environment. This temperature, in the first approximation, is constant during the cooling process. The mass flow of cooling air, that is to say the inducted mass flow of the gas turbine, at constant cooling speed, is also practically constant during the cooling process. The dissipated heat is proportional to the difference between metal temperature and cooling-air temperature. This is highest at the start of the cooling process and therefore leads to the highest temperature gradients in the material and to the faster cool-down. Over time, the metal temperatures and the resulting temperature gradients reduce. Therefore, the thermal loading also becomes smaller. As soon as the loading reduces, cooling is therefore carried out conventionally more slowly than would be permissible.

One possibility for accelerating the cooling is to increase the mass flow of cooling air. This can be realized by increasing the cooling speed. In this case, the aim is not to exceed the limits of the thermal loading but to operate at these limits for as long as possible during the cooling process in order to realize a fast cooling. In this case, various components have to be taken into consideration during the cooling-down process. The limiting, most critical component can change during the cooling-down process. For example, a thin component, such as a combustor plate which cools down quickly, can initially be the limiting component. A further component, such as the rotor or a thick casing part, cools down considerably more slowly and can become the limiting component later when the first component has already cooled down to a non-critical temperature.

In one embodiment, the cooling speed is controlled as a function of one or more critical component temperatures or critical temperature gradients. The speed is typically inversely proportional to a critical temperature. More simply, in a further embodiment, the cooling speed is increased in steps. The increase can be carried out for example in steps in each case upon falling below a next-lower critical temperature.

Since the temperature profile during cooling is essentially known, the cooling speed in a further embodiment is increased as a function of time. The cooling speed can also be increased accordingly in steps in dependence upon time.

As the critical limit, the cool-down can be selected over time itself or over a temperature gradient which is brought about as a result of the cool-down in a component.

Depending upon the embodiment, a critical temperature gradient, for example between component surface and component interior, can be measured directly or be approximated from the profile of the surface temperature over time. The change in temperature which is measured on the surface is in this case proportional to the heat dissipation. A temperature gradient in the material is furthermore proportional to the heat dissipation.

In a further embodiment, at least two functions for determining the cooling speed in dependence upon a critical temperature are given, these leading to different service life consumption as a result of the cool-down. The operator can therefore determine within prescribed limits which service life consumption he will apply for the fast cool-down in order to enable quick access to the gas turbine. The higher the selected speed or speed profile, the greater the service life consumption is. In another embodiment, the operator specifies a permissible service life consumption and the control computer of the gas turbine operates along a corresponding speed curve.

Another aspect includes a gas turbine useful for carrying out a method embodying principles of the present invention. Such a gas turbine can be characterized in that it has a drive which allows the gas turbine to be rotated in a controlled manner in the lower speed range for the cool-down. A speed range of up to 30% of the nominal speed is typically referred to as a lower speed range. A speed range of up to 20% or even only up to about 5% or 10% of the nominal speed can be adequate for fast cool-down. In this case, the speed at which the gas turbine is operated, if it is coupled to electricity mains via a generator for power generation, is referred to as the nominal speed.

The drive of the gas turbine is typically realized via its generator which, by a so-called “static frequency converter”, is operated as a motor.

In one embodiment, the gas turbine controller has time-dependent curves of the nominal speed, which it follows for fast cooling.

In a further embodiment, the gas turbine has at least one temperature measuring device in at least one critical component. In another embodiment, the gas turbine has at least one pair of temperature measuring points for measuring a temperature gradient in at least one critical component. This, for example, can be a pair of temperature measuring points of which one is applied on the component surface and a second is applied at a defined distance beneath the surface.

Further advantages and developments are described in the description and in the attached drawings. All the exemplified advantages can be applied not only in the respectively disclosed combinations, but can also be applied in other combinations or applied alone without departing from the scope of the invention.

One embodiment can be characterized, for example, by a gas turbine which is equipped with a “wet compression system” for power augmentation, as is known from EP 1454044, for example. This system is activated for further acceleration of the cooling process after a minimum speed. In one embodiment, the injected amount of water is increased proportionally to the inducted mass flow of air of the gas turbine. For simplicity, it can additionally be assumed that the inducted mass flow of air is proportional to the speed. Therefore, the injected amount of water can be increased proportionally to the speed. The minimum speed for starting the water injection is typically within the order of magnitude of the compressor washing speed of the gas turbine.

A further embodiment is the application of a method to a gas turbine with sequential combustion, as is known from EP 0620362, for example, and also a gas turbine with sequential combustion useful for carrying out the method.

If control of the injected amount is carried out via the activation of groups of injection nozzles, the proportional increase of the injected amount is approximated in steps.

### BRIEF DESCRIPTION OF THE DRAWINGS

Exemplary embodiments of the invention are schematically represented in FIGS. 1 to 3.

In the drawing:

FIG. 1 shows a gas turbine with temperature measuring devices for determining the critical temperatures Tₖ,

FIG. 2 shows the exemplary profile of the speed and of a resulting critical temperature Tₖ over time,

FIG. 3 exemplarily shows the profile of the speed in order to realize a constant gradient in a critical temperature Tₖ.

### DETAILED DESCRIPTION OF EXEMPLARY EMBODIMENTS

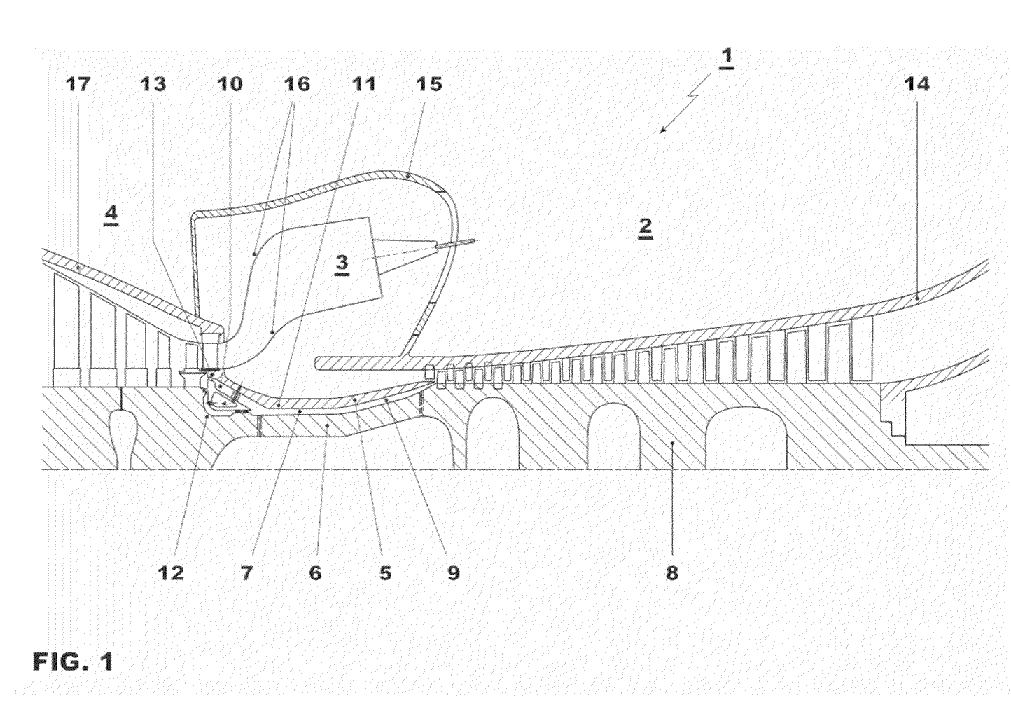

FIG. 1 schematically shows a gas turbine useful for implementing a method according to principles of the present invention. The gas turbine 1 includes, in a known manner per se, at least one compressor 2, at least one combustor 3 and at least one turbine 4. A generator is typically coupled to a rotor 8 at the cold end of the gas turbine 1, that is to say, at the compressor 2.

During normal operation, in the combustor 3 fuel is mixed and combusted with gases which are compressed in the compressor 2. The hot gases are expanded in the subsequent turbine 4, with output of work. All components which come directly or indirectly in contact with the hot gases are heated up in the process. These are especially the rotor 8, which is often also referred to as a shaft, the so-called rotor cover 5, the combustor 3, the turbine 4 and also the casing parts of the gas turbine, i.e., turbine casing 17, combustor casing 15 and compressor casing 14.

The middle part of the gas turbine, i.e., the region between the compressor end and the turbine inlet, is represented for a typical embodiment of a stationary gas turbine. The turbine cooling air for the rotating part of the turbine is extracted at the compressor end, and in an annular passage 7 between rotor cover 5 and the middle part of the rotor 8 which is referred to as a drum 6, is guided past the combustor 3 to the turbine 4. Before entry into the rotating part of the turbine 4, the air is provided with a swirl via a swirl baffle 13.

The region of the drum 6 and the adjoining rotor disks and also the rotor cover 5 are thermally highly loaded. The temperature rise of the air which flows through the annular passage 7 can be used in this case as a measurement for the heat discharge of critical components in the middle section of the machine. The temperature rise of the air is proportional to the discharged heat. The temperature rise is furthermore inversely proportional to the amount of air which flows through the annular space and therefore inversely proportional to the speed of the gas turbine. The temperature rise can be determined, for example, as the difference from a measurement of the cooling-air inlet temperature 9 in the entry region of the annular space 7 and a measurement of the cooling-air end temperature 10 when discharging from the annular space 7.

The permissible cooling speed “n” is determined in one embodiment as a function of this cooling-air temperature difference. For a more accurate control, in a further embodiment the permissible cooling speed n is determined as a function of the cooling-air temperature difference and the current cooling speed.

In one embodiment, the permissible cooling speed n is determined as a function of a critical temperature Tₖ of the rotor cover 5. For this, in the example which is shown, a measuring device 11 of the critical temperature of the rotor cover is installed on the rotor cover 5.

In a further embodiment, the permissible cooling speed n is determined as a function of a critical temperature Tₖ of the rotor 8. For this, in the example which is shown, a measuring device 12 of the critical temperature of the rotor is installed on the rotor 8.

Depending upon the component, instead of a critical temperature Tₖ, a critical temperature difference in the material of a component or between the surface and a measuring point inside a component can be advantageously determined, and, depending upon this temperature difference, the permissible cooling speed n can be determined.

The critical temperatures Tₖ or temperature differences which are exemplarily referred to can be used individually or in combination. Moreover, further critical temperatures Tₖ or temperature differences, such as combustor-liner temperatures or casing temperatures or temperature differences in a liner wall or casing wall, can be used. The so-called combustor liners 16 are components which delimit the sides of the combustor 3 and direct the flow to a downstream turbine.

For combining a plurality of critical temperatures or temperature differences, the associated permissible cooling speed is typically determined for each critical temperature Tₖ or temperature difference which is to be taken into consideration. The overall limiting permissible cooling speed n, at which the gas turbine is to be cooled down, is equal to the minimum of all the permissible cooling speeds.

The function or dependency by which the permissible cooling speed is determined can be presented, for example, as an approximation function or in a table which is stored in the control computer of the gas turbine.

FIG. 2 schematically shows the profile of a normalized critical temperature Tₖ over time t. In the example which is shown, the gas turbine, after a time t₁, is rotated at a constant normalized first cooling speed n₁ for cooling. For faster cooling down, the normalized cooling speed n, after a time t₂, is increased to a second normalized cooling speed n₂. The associated normalized temperature profile Tₖ is shown by an unbroken line. For comparison, the normalized temperature profile Tₖ' is shown by a broken line, which results if even after the time point t₂ the normalized cooling speed n is kept constant at the normalized first cooling speed nᵢ. In FIG. 2, it is clear to see how the critical temperature Tₖ falls significantly more quickly as a result of the proposed method, allowing an earlier shutdown.

After increasing the cooling speed to the second normalized cooling speed n₂, the critical temperature Tₖ falls with a high gradient. Since the component is already relatively cool, it can tolerate this high gradient which is considerably higher than the gradient which is reached at time t₁, without additional detriment to the service life.

In the example which is shown, the critical temperature Tₖ is normalized with the maximum critical temperature which is reached at the start of the cool-down period. The cooling speed is normalized with the maximum cooling speed n₂ which is reached in the second step.

In addition to a simple increase of the normalized cooling speed in two steps, an increase in a multiplicity of small steps or with one gradient is conceivable. In this case, after reaching a respective temperature limit or a respective time limit, the cooling speed is increased in steps to a higher cooling speed (nᵢ) in each case and cooling is then carried out at this higher cooling speed (nᵢ) until reaching the next limit in each case.

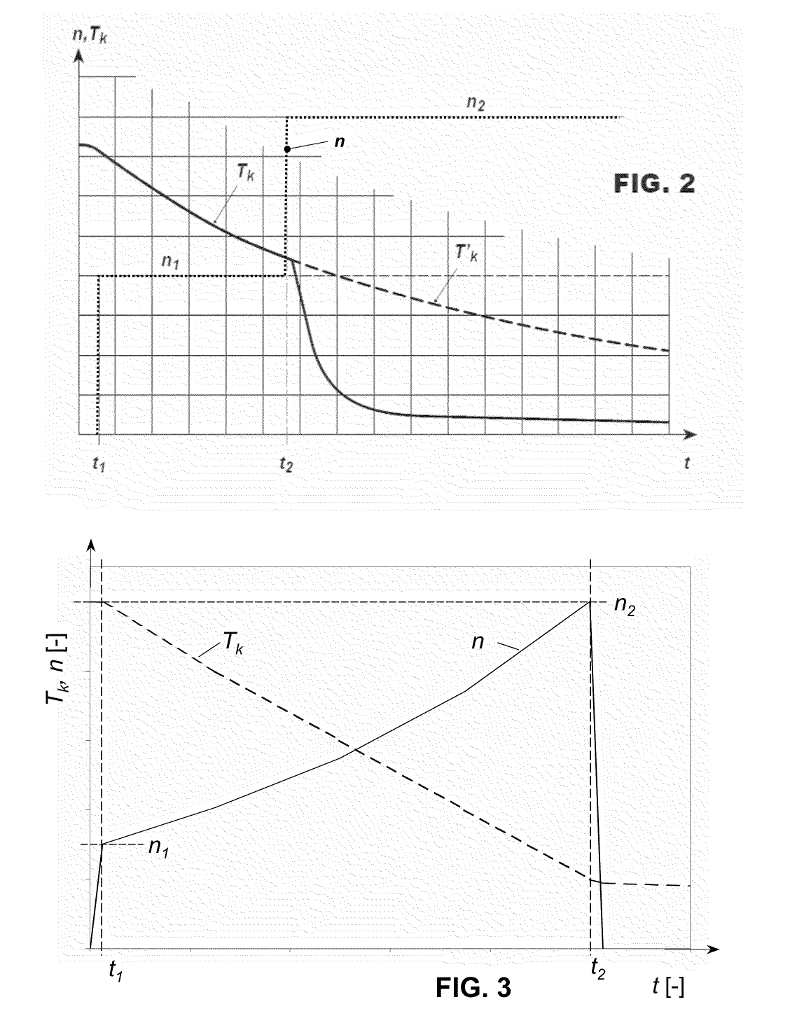

FIG. 3 schematically shows a further example of the profile of a normalized critical temperature Tₖ over time t. In the example which is shown here, the normalized cooling speed n, starting from an initial value n₁ over time t, is increased so that the gradient by which the normalized critical temperature Tₖ reduces, remains constant.

In the example which is shown, the critical temperature Tₖ is normalized with the maximum critical temperature which is reached at the start of the cool-down period. The cooling speed is normalized with the maximum cooling speed n₂ which is reached at the end of the cool-down period.

In a further embodiment, which is not shown, the cooling speed (n) increases proportionally to the time until a maximum value of the cooling speed is reached. After reaching the maximum value, the gas turbine is cooled further with the maximum value of the cooling speed until the gas turbine is sufficiently cooled and can be stopped.

### LIST OF DESIGNATIONS

1 Gas turbine

2 Compressor

3 Combustor

4 Turbine

5 Rotor cover

6 Rotor drum

7 Annular passage

8 Rotor

9 Cooling-air inlet-temperature measuring device

10 Cooling-air end-temperature measuring device

11 Temperature measuring device of the critical temperature of the rotor cover

12 Temperature measuring device of the critical temperature of the rotor

13 Swirl baffle

14 Compressor casing

15 Combustor casing

16 Combustor liner

17 Turbine casing

Tₖ Critical temperature

n Permissible cooling speed

n₁ First cooling speed

n₂ Second cooling speed

t Time

t₁ Start of cooling at first cooling speed n₁

t₂ Start of cooling at second cooling speed n₂

Tₖ Normalized critical temperature

n Normalized cooling speed

n₁ First normalized cooling speed

n₂ Second normalized cooling speed

nᵢ i-th normalized cooling speed

t Normalized time

t₁ Start (normalized time) of cooling at first cooling speed n₁

t₂ Start (normalized time) of cooling at second cooling speed n₂

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A method for cooling down a gas turbine after operation of the gas turbine, the method comprising:
operating a rotor of the gas turbine at a cooling speed (n) to cool down the gas turbine; and
controlling the cooling speed (n) as a function of at least one critical temperature (Tₖ), of time, or of both.

2. The method as claimed in claim 1, wherein said at least one critical temperature (Tₖ) is a cooling-air temperature of the gas turbine.

3. The method as claimed in claim 1, further comprising:
calculating the difference between at least one pair of critical temperatures (Tₖ); and
wherein controlling the cooling speed (n) comprises controlling as a function of said difference, of time, or of both.

4. The method as claimed in claim 1, wherein said at least one critical temperature (Tₖ) is a temperature of the rotor cover.

5. The method as claimed in claim 1, wherein said at least one critical temperature (Tₖ) is a temperature of a casing section or of the rotor.

6. The method as claimed in claim 1, wherein controlling the cooling speed (n) comprises controlling proportionally to time.

7. The method as claimed in claim 1, wherein controlling the cooling speed (n) comprises increasing the cooling speed (n) proportionally to time until a maximum value is reached, and thereafter maintaining the cooling speed (n) at said maximum value.

8. The method as claimed in claim 1, wherein controlling the cooling speed (n) comprises:
first maintaining the cooling speed (n) constant at a first cooling speed (n₁) until a critical temperature or a time limit is reached;
thereafter increasing the cooling speed to a second cooling speed (n₂); and
thereafter maintaining the cooling speed at said second cooling speed (n₂).

9. The method as claimed in claim 1, wherein controlling the cooling speed (n) comprises:
first maintaining the cooling speed (n) constant at a first cooling speed (n₁)until a temperature limit or a time limit is reached;
thereafter increasing the cooling speed in steps to a higher cooling speed (nᵢ); and
thereafter maintaining the cooling speed at said higher cooling speed (nᵢ) until reaching another temperature or time limit, until a maximum cooling speed is reached.

10. The method as claimed in claim 1, further comprising:
determining at least two permissible cooling speeds (n) as functions of at least two critical temperatures or temperature differences; and
wherein controlling the cooling speed comprises controlling at the lowest of said at least two permissible cooling speeds (n).

11. A gas turbine comprising:
a rotor configured and arranged to be operated at a cooling speed (n) to cool down the gas turbine; and
means for controlling the cooling speed (n) as a function of at least one critical temperature (Tₖ), of time, or of both.

12. The gas turbine as claimed in claim 11, further comprising:
a component which is thermally highly loaded when the gas turbine is shutting down; and
an air passage;
wherein the means for controlling comprises at least one temperature measuring device configured and arranged to measure a temperature (Tₖ) which is critical for the cool-down of the gas turbine, the at least one temperature measuring device being installed on said component or in said air passage.

13. The gas turbine (1) as claimed in claim 12, wherein:
the component comprises a rotor cover; and
the at least one temperature measuring device is installed on the rotor cover.

14. The gas turbine as claimed in claim 12, wherein:
the component comprises the rotor; and
the at least one temperature measuring device is installed on the rotor.

15. The gas turbine as claimed in claim 12, wherein:
the air passage comprises a cooling air passage; and
the at least one temperature measuring device is installed in the cooling air passage.
